(19) United States
(12) Patent Application Publication
(10) Pub. No.: US 2016/0098771 A1
(43) Pub. Date: Apr. 7, 2016

(54) SYSTEM AND METHOD FOR NEGOTIATING TERMS OF SALE

(71) Applicant: THE REYNOLDS AND REYNOLDS COMPANY, Kettering, OH (US)

(72) Inventors: Robert Brockman, Houston, TX (US); Jessica Harris, Houston, TX (US)

(21) Appl. No.: 14/877,366

(22) Filed: Oct. 7, 2015

Related U.S. Application Data
(60) Provisional application No. 62/061,006, filed on Oct. 7, 2014.

(51) Int. Cl. G06Q 30/06

(52) U.S. Cl. CPC G06Q 30/0611

(57) ABSTRACT

A method for negotiating terms of sale between a customer and a sales manager includes a sales terminal and a desking terminal. The sales terminal is usable by the customer and/or a salesperson, and the desking terminal is usable by the sales manager. The customer and/or salesperson transmit, using the sales terminal, a deal request to the sales manager on the desking terminal. The sales manager may then create a deal proposal using the desking terminal, and transmit the deal proposal to the customer on the sales terminal. The customer may accept or revise a proposal included with the deal proposal. Any revised proposal may be transmitted to the sales manager on the desking terminal. The sales manager may then formulate a new deal proposal based on the customer's revised proposal. The desking terminal may provide the sales manager with detailed information for use during the negotiation.

### CROSS-REFERENCE TO RELATED APPLICATIONS

The present application claims priority from U.S. Provisional Patent Application No. 62/061,006 filed on Oct. 7, 2014, the entirety of which is incorporated herein by reference.

### TECHNICAL FIELD/FIELD OF THE DISCLOSURE

The present disclosure relates generally to computerized communication systems between terminals, and specifically to systems and methods for negotiating terms of sale for a purchase.

### BACKGROUND OF THE DISCLOSURE

When selling vehicles, a dealership may use a salesperson to work with a customer to determine the type of vehicle, options, and other vehicle-related items that a customer wishes to purchase. “Purchase” includes both payment for the vehicle, such as by cash or loan, or lease of the vehicle. Typically, salespersons do not have deal making authority, i.e., the salesperson who works directly with the customer may not have the authority to decide terms of sale, such as vehicle price, payments, financing, and trade-in value of existing vehicles (“terms”). Instead, the dealership may use a “sales manager” to decide terms between the customer and the dealership.

### SUMMARY

The present disclosure provides for a method. The method may include providing a sales terminal and a desking terminal, each of the sales and desking terminals adapted to be capable of transmitting data to and receiving data from the other terminal. The method may also include creating a deal request on the sales terminal. The method may also include transmitting the deal request from the sales terminal to the desking terminal. The method may also include claiming the deal request on the desking terminal. The method may also include creating a deal proposal on the desking terminal. The method may also include transmitting the deal proposal from the desking terminal to the sales terminal.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a diagram of a negotiation system consistent with at least one embodiment of the present disclosure.

FIG. 2 is a flowchart of a negotiation system consistent with at least one embodiment of the present disclosure.

FIG. 3 is a screen shot of a negotiation system consistent with at least one embodiment of the present disclosure.

FIG. 4 is a screen shot of a negotiation system consistent with at least one embodiment of the present disclosure.

FIG. 5 is a screen shot of a negotiation system consistent with at least one embodiment of the present disclosure.

FIG. 6 is a screen shot of a negotiation system consistent with at least one embodiment of the present disclosure.

FIG. 7 is a screen shot of a negotiation system consistent with at least one embodiment of the present disclosure.

FIG. 8 is a screen shot of a negotiation system consistent with at least one embodiment of the present disclosure.

FIG. 9 is a screen shot of a negotiation system consistent with at least one embodiment of the present disclosure.

FIG. 10 is a screen shot of a negotiation system consistent with at least one embodiment of the present disclosure.

FIG. 11 is a screen shot of a negotiation system consistent with at least one embodiment of the present disclosure.

FIG. 12 is a screen shot of a negotiation system consistent with at least one embodiment of the present disclosure.

FIG. 13 is a screen shot of a negotiation system consistent with at least one embodiment of the present disclosure.

FIG. 14 is a screen shot of a negotiation system consistent with at least one embodiment of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

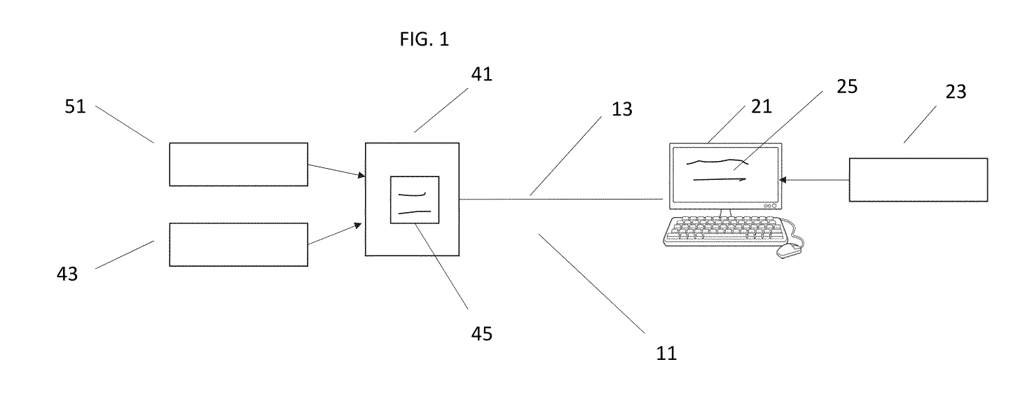

As depicted in FIG. 1, in some embodiments of the present disclosure, a system for negotiating terms of sale, negotiation system 11, may include desking terminal 21 and one or more sales terminals 41. Although FIG. 1 depicts only one desking terminal 21, one of ordinary skill in the art will recognize that certain embodiments may include a plurality of desking terminals. Desking terminal 21 may be located apart from sales terminal 41. Desking terminal 21 may be interconnected with sales terminals 41 to provide communication therebetween. In some embodiments, the interconnection may be accomplished by network 13 which may be, for example and without limitation, an internal network such as a wired and/or wireless network including any additional hardware. In some embodiments, all or part of network 13 may include a link between two or more devices over a WAN such as the internet. Although described as being sent or received by desking terminal 21 and sales terminal 41, one having ordinary skill in the art with the benefit of this disclosure will understand that communications sent by either terminal may be routed through one or more intermediary systems including, for example and without limitations, one or more servers. Likewise, information described hereinbelow as transmitted or received by a terminal may remain stored within a server or terminal until accessed or requested by another terminal. In some embodiments, desking terminal 21 and sales terminal 41 may be computer devices, including but not limited to, desktop computers, laptop computers, computer terminals, tablets, slates, or smartphones. In some embodiments, desking terminal 21 may be adapted to be utilized by a user having authority to make and approve terms of sale for a transaction negotiated using negotiation system 11, referred to herein as sales manager 23. In some embodiments, sales terminal 41 may be adapted to be utilized by one or more users including, for example and without limitation, salesperson 43 or customer 51, where customer 51 is a person or entity desiring to make a purchase.

In some embodiments, each desking terminal 21 may be associated with one or more sales managers 23. In some embodiments, each sales manager 23 may have an associated desking terminal 21. In some embodiments, each sales manager 23 may have a user id or account set up to allow sales manager 23 to be associated with desking terminal 21 which sales manager 23 is utilizing at any given time. In some embodiments, desking terminal 21 is adapted to allow sales manager 23 an interface through which sales manager 23 may enter and receive data. In some embodiments, desking terminal 21 may provide a user interface such as desking graphical user interface (GUI) 25. Desking GUI 25 may be adapted to allow sales manager 23 to interact with and display information entered into any desking terminal 21 or sales terminal 41. In some embodiments, desking terminal 21 may be positioned apart from sales terminal 41. In some embodiments, for example, desking terminal 21 may be located in the office of sales manager 23.

In some embodiments, each sales terminal 41 may be associated with a specific salesperson 43. In some embodiments, each salesperson 43 may have an associated sales terminal 41. In some embodiments, each salesperson 43 may have a user id or account set up to allow salesperson 43 to be associated with sales terminal 41 which salesperson 43 is utilizing at any given time. In some embodiments, sales terminal 41 is adapted to allow salesperson 43 an interface through which salesperson 43 may enter and receive data. In some embodiments, sales terminal 41 may provide a user interface such as sales GUI 45. Sales GUI 45 may be adapted to allow salesperson 43 to interact with and display information entered into sales terminal 41 or sent from desking terminal 21. In some embodiments, sales terminal 41 may be positioned apart from desking terminal 21. In some embodiments, for example, sales terminal 41 may be located in an office of salesperson 43 or a dedicated sales area.

In some embodiments, one or more sales terminals may be associated with customer 51. In a non-limiting embodiment, the sales terminal 41 may be used by customer 51 without assistance from salesperson 43. In some embodiments, each customer 51 may have a user id or account set up to allow customer 51 to be associated with sales terminal 41 which customer 51 is utilizing at any given time. In some embodiments, sales terminal 41 is adapted to allow customer 51 an interface through which customer 51 may enter and received data. In some embodiments, sales terminal 41 may provide a user interface such as sales GUI 45. Sales GUI 45 may be adapted to allow customer 51 to interact with and display information entered into sales terminal 41 or sent from desking terminal 21. In some embodiments, sales terminal 41 may be positioned apart from desking terminal 21. In certain embodiments, GUI 45 may be associated with one or more webpages through which customer 51 may enter or received data from desking terminal 21.

In some embodiments, sales terminal 41 may be accessible and viewable by both customer 51 and salesperson 43. In some embodiments, sales terminal 41 may be accessible by only salesperson 43. In some embodiments, sales terminal 41 may be accessible by customer 51 only during certain portions of the negotiation process. Although discussed herein as customer 51 entering information into sales terminal 41, one having ordinary skill in the art with the benefit of this disclosure will understand that either customer 51 or salesperson 43 may physically enter or cause to be entered information in any given operation described without deviating from the scope of this disclosure, unless specifically stated.

Although not depicted in FIG. 1, one having ordinary skill in the art with the benefit of this disclosure will understand that desking terminal 21 and sales terminal 41 may additionally connect to one or more servers or databases as discussed herein or otherwise without deviating from the scope of this disclosure.

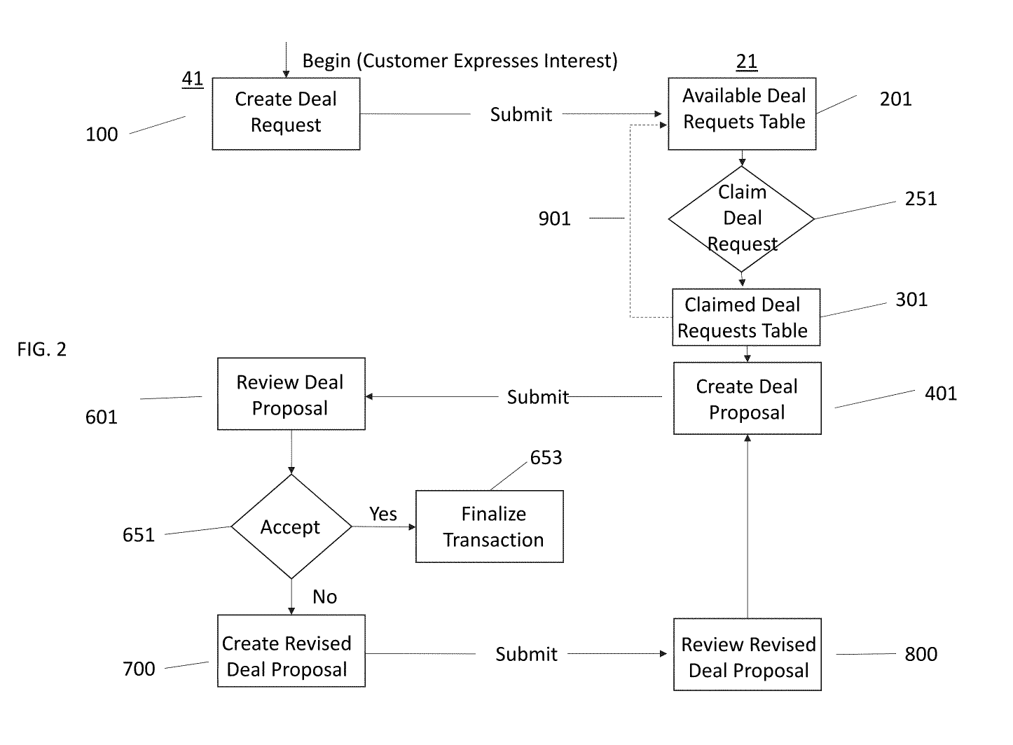

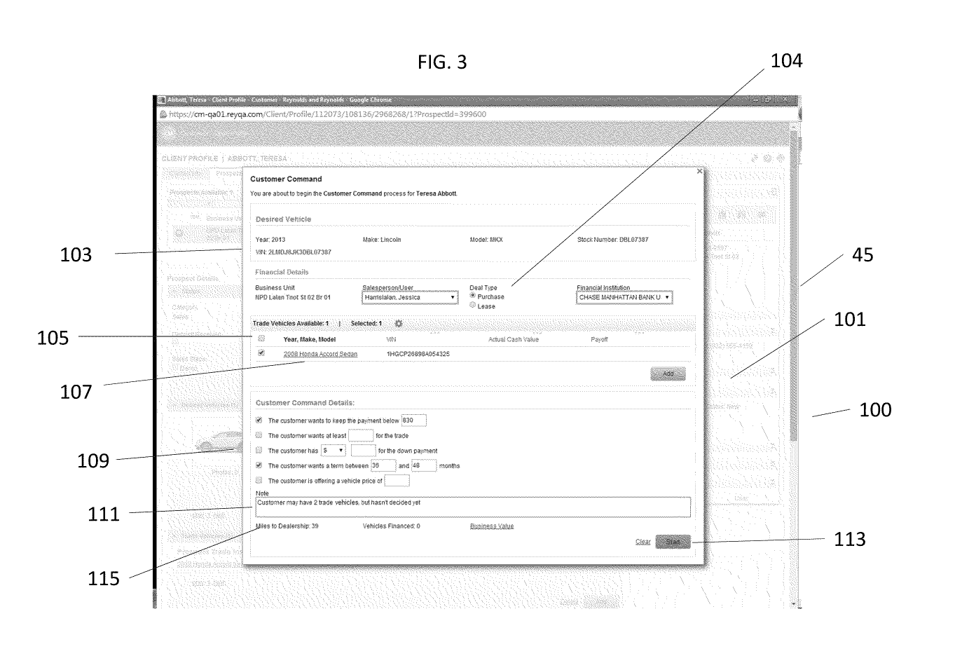

FIG. 2, depicts a negotiation system flowchart consistent with embodiments of the present disclosure. In some embodiments, a customer 51 and/or salesperson 43 may prepare deal request 100. In some embodiments, some or all of the information in deal request 100 may be input into sales terminal 41 by a form, as understood in the art, fillable by customer 51. In some such embodiments, the form may be questionnaire 101, which may be displayed, as depicted in FIG. 3, by sales GUI 45 of sales terminal 41. Information in deal request 100 may include at least one datum entered into questionnaire 101 through sales GUI 45. Deal request 1000 may be stored in a non-transitory, tangible computer readable storage medium. In some embodiments, information contained in deal request 100 may be relayed to sales manager 23. Information entered into questionnaire 101 may include information about customer 51, vehicle information 103, vehicle financing information 104, trade-in information 105, or desired terms of sale 109, which are described below herein.

In some embodiments, deal request 100 may include a deal identifier, allowing subsequent correspondences in the deal negotiation to be linked.

In some embodiments, deal request 100 may include information about customer 51. Customer information may include customer 51's name, address, financial information, etc. In some embodiments, customer 51 information may be entered into sales terminal 41 at the time of the negotiation. Customer information may be stored in a non-transitory, tangible computer readable storage medium. In some embodiments, some or all of customer 51 information may be imported from previously entered or known customer information from a customer information database maintained by the dealership. In some such embodiments, customer 51 may enter any additional or missing customer information at the time of the negotiation. In some embodiments, the additional or missing customer information may be added to customer 51 information database directly. In some embodiments, at least some of customer 51 information may be made available to salesperson 43 or sales manager without appearing in deal request 100. In some embodiments, deal request 100 may include one or more customer identifiers which will allow sales manager 23 to, when reviewing deal request 100, access customer information from a customer 51 information database (not shown). In some embodiments, customer information from a customer 51 information database may be available on sales GUI 45. In some such embodiments, sales GUI 45 may include a link or button which allows salesperson 43 or customer 51 to view customer information. In some embodiments, the customer information may include a business value of customer 51 for the dealership including, for example and without limitation, total sales, new vehicle sales, used vehicle sales, and service sales from the dealership to customer 51. In some embodiments, customer information may include previous deal requests 100 for customer 51, such as, for instance, deal requests 100 from previous dates. In some embodiments, customer information may include a credit score or credit report. In some embodiments, sales GUI 45 may prevent customer information from being viewed by customer 51.

In some embodiments, as depicted in FIG. 3, deal request 100 may include vehicle information 103 about the vehicle customer 51 is interested in purchasing. In some embodiments, vehicle information 103 may be entered into sales terminal 41 at the time of the negotiation. In some embodiments, some or all of vehicle information 103 may be imported from previously entered or known vehicle information 103 from a vehicle information database (not shown) maintained by the dealership. In some such embodiments, customer 51 or salesperson 43 may enter any additional or missing vehicle information 103 at the time of the negotiation. In some embodiments, the additional or missing vehicle information 103 may be added to vehicle information database directly. In some embodiments, at least some of vehicle information 103 may be made available to sales manager 23 without appearing in deal request 100. In some embodiments, deal request 100 may include one or more vehicle identifiers which will allow sales manager 23 to, when reviewing deal request 100, access vehicle information 103 from vehicle information database. In some embodiments, vehicle information 103 from the vehicle information database may be available on sales GUI 45. In some such embodiments, sales GUI 45 may include a link or button which allows salesperson 43 or customer to view detailed vehicle information 103. In some embodiments, vehicle information 103 may include, for example and without limitation, a model year, make, model, mileage, color, VIN, stock number, vehicle price, photographs, available and installed options, etc. In certain embodiments, deal request 100 may include vehicle information 103 from more than one vehicle.

Deal request 100 may also include vehicle financing information 104. Vehicle financing information 104 may include whether customer 51 is interested in purchasing or leasing the vehicle, and/or the financial institution that the customer may use to finance the purchase or lease.

In some embodiments, deal request 100 may also include trade-in vehicle information 105 about any trade-in vehicles customer 51 may be interested in trading-in towards the purchase or lease of the vehicle customer 51 is interested in purchasing. The trade-in vehicle information 105 may include, for example and without limitation, the model year, make, model, mileage, VIN, current financing terms, current financing status, UVM data, market based pricing data, etc. In some embodiments, one or more trade-in vehicles 107 may be entered into deal request 100. Trade-in vehicle information may, for instance, be added by customer 51 or salesperson 43, or it may be retrieved from a database.

In some embodiments, deal request 100 may include one or more desired terms of sale 109 desired by customer 51. Although described as terms of sale, one having ordinary skill in the art with the benefit of this disclosure will understand that the sale may include a purchase or a lease without deviating from the scope of this disclosure. Desired terms of sale 109 may include, for example and without limitation, a maximum or desired regular or irregular payments (including such arrangements as balloon payments) for the vehicle, a desired trade-in value for any trade-in vehicles, a down payment amount, desired financing term, desired financing rate, overall price for the vehicle, and whether customer 51 desires to purchase or lease the vehicle. In some embodiments, customer 51 may provide information for each desired term of sale. In some embodiments, customer 51 may select only a subset of desired terms of sale 109 to provide desired terms of sale. For example, customer 51 may be more interested in a desired maximum regular payment and desired financing term than an overall price for the vehicle. In such a situation, customer 51 may provide only desired terms of sale 109 for the desired maximum regular payment and financing term while not providing a desired overall price. In some embodiments, deal request 100 may also allow customer 51 or salesperson 43 to include one or more notes 111 which may be relevant to sales manager 23 in reviewing desired terms of sale 109 of deal request 100.

In some embodiments, deal request 100 may include information 115 related to customer 51 including the distance of the customer 51 residence to the dealership and vehicles financed by customer 51.

Once completed, customer 51 or sales person 43 may submit deal request 100. In some embodiments, sales GUI 45 may include a button or link, depicted in FIG. 3 as “start” button 113, to submit deal request 100. As one of ordinary skill in the art with the benefit of this disclosure will recognize, submission of deal request 100 may be accomplished by other means, including, but not limited to, completion of the deal request, oral command, other terminal interactive means. Once submitted, deal request 100 may be sent from sales terminal 41 to desking terminal 21, as depicted in FIG. 2, to be accessed by a sales manager 23. In some embodiments, one or more received deal request indicators (not shown) may indicate that a deal request has been received. Received deal request indicators may include, for example and without limitation, sounds, lights, or indicators in desking GUI 25. Indicators in desking GUI 25 may include without limitation popups, alert boxes, dialog boxes, or graphical indications that a deal request has been received.

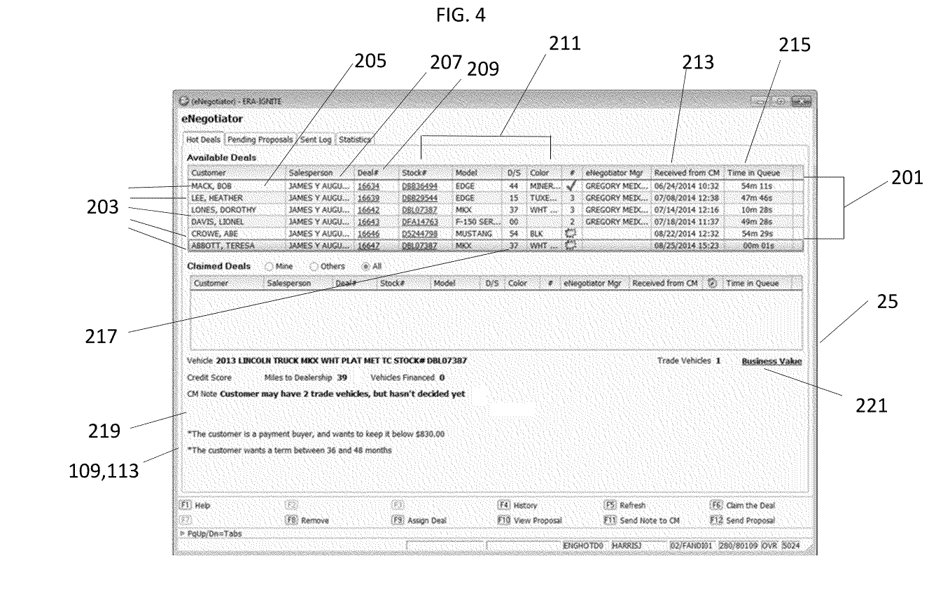

In some embodiments, the dealership may have more than one sales manager 23, each sales manager 23 having a desking terminal 21. In some such embodiments, deal request 100 may be sent to each desking terminal 21. The existence of deal request 100 appears as available deal request 203 (entitled “Available Deals on desking GUI 25 as depicted in FIG. 4). Available deal requests 203 are not associated with a sales manager 23, i.e., available deal requests 203 have not been claimed by any sales manager 23 or were previously claimed by a sales manager and reverted based on expiration of a predetermined period of time as described herein below. Available deal requests 203 may be displayed by desking GUI 25 and may, in some embodiments, be displayed in available deal requests table 201. Available deal requests 203 may be stored in a non-transitory, tangible computer readable storage medium. In some embodiments, available deal requests table 201 may display information relating to each available deal request 203 including one or more of, without limitation, customer information 205, the associated salesperson name 207, the deal identifier 209, vehicle information 211, the time 213 each available deal request 203 appeared in available deal request table 201, and the time elapsed 215 since each available deal request 203 appeared in available deal request table 201. In some embodiments, only a selected portion of customer information 205 and vehicle information 211 may be shown in available deal request table 201. For example, only customer information 205 and vehicle information 211 desired to be seen by sales manager 23 may be displayed. In some embodiments, sales manager 23 may select which customer information 205 and vehicle information 211 is displayed. In some embodiments, available deal requests table 201 may display days in stock information 217. In some embodiments, days in stock information 217 may be retrieved from a days in stock database. Available deal requests table 201 may further include a column that includes a total time in queue (not shown) that may indicate the sum of the time the available deal has been in the queue through successive iterations. In some embodiments, available deal requests table 201 includes a column that includes a total time in queue the available deal has been in the queue for the particular iteration.

In some embodiments, by selecting an available deal request 203, additional information 219 relating to the selected available deal request 203 may be displayed by desking GUI 25. Additional information 219 may include, for example and without limitation, customer information, vehicle information, trade-in vehicle information, dealership inventory information, and desired terms of sale 109 submitted by customer 51 in deal request 100 as well as any notes 113 included therewith. In some embodiments, customer information from customer 51 information database may be available on desking GUI 25. In some such embodiments, desking GUI 25 may include a link or button which allows sales manager 23 to view detailed customer information. In some embodiments, the detailed customer information may include a business value 221 of customer 51 for the dealership including, for example and without limitation, total sales, new vehicle sales, used vehicle sales, and service sales from the dealership to customer 51.

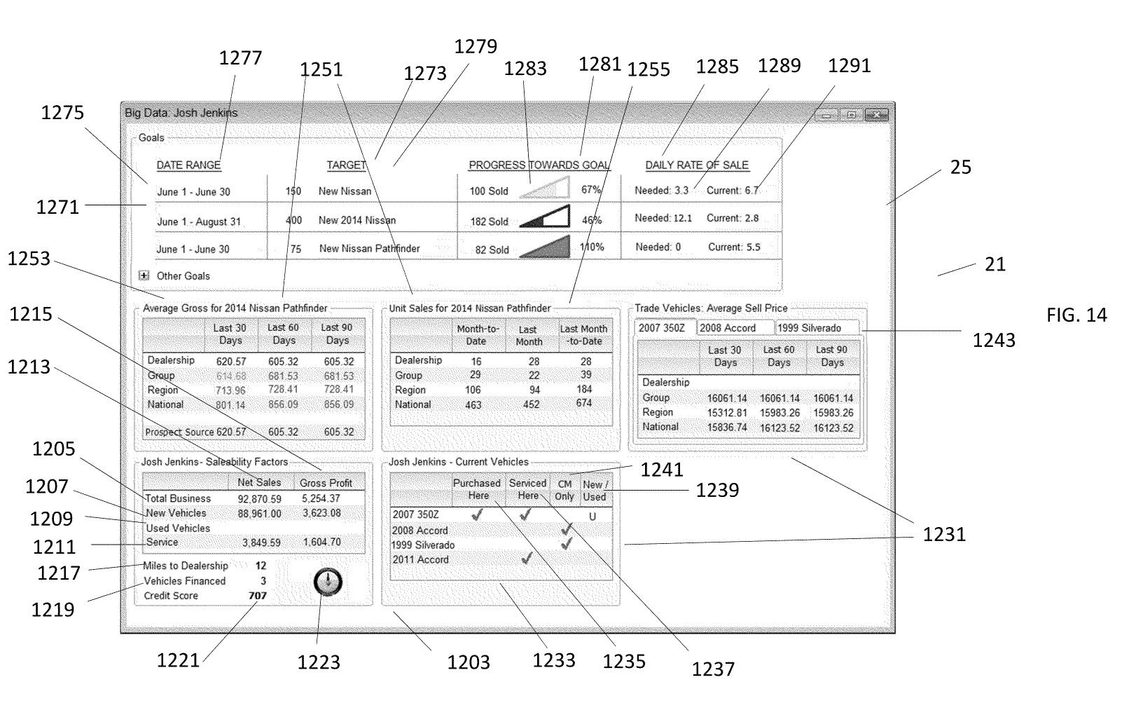

In some embodiments, desking GUI 25 may allow sales manager 23 to view detailed information relating to the deal request 203. As depicted in FIG. 14, detailed information may include detailed customer information 1203, detailed trade-in information 1231, detailed vehicle information 1251, and detailed dealership information 1271. Detailed customer information 1203 may be stored in a non-transitory, tangible computer readable storage medium. In some embodiments, detailed customer information 1203 may include, for example and without limitation, total business 1205 generated by customer 51, new vehicle sales 1207, used vehicle sales 1209, and service sales 1211. In some embodiments, any or all of the customer sales data may be broken down by net sales 1213 and gross profit 1215. In some embodiments, detailed customer information 1203 may also include the distance 1217 customer 51 lives from the dealership and the number of vehicles financed 1219 by customer 51. In some embodiments, detailed customer information 1203 may also include credit score 1221 calculated for customer 51. In some embodiments, detailed customer information 1203 may be used to calculate a “favorability score” for customer 51 which may, for example and without limitation, indicate the likelihood that customer 51 will be a repeat customer or a profitable customer for the dealership. In some embodiments, the favorability score may be displayed as favorability indicator 1223. In some embodiments, favorability indicator 1223 may indicate the score to sales manager 43 by a graphical indication.

In some embodiments, detailed trade-in information 1231 may include a list of vehicles 1233 currently owned by customer 51. In some embodiments, list of vehicles 1233 may include indicators of whether each vehicle was purchased at the dealership (1235), whether the vehicle is serviced at the dealership (1237), whether the vehicles were purchased new or used (1239), and indications that the vehicles are known only from customer-provided information (1241). In some embodiments, detailed trade in information 1231 may include sales information 1243 for each vehicle in list of vehicles 1233. In some embodiments, sales information 1243 may include dealership, group, regional, and national sales statistics. In some embodiments, sales information 1243 may be subdivided by time period.

In some embodiments, detailed vehicle information 1251 may include sales information for the make and model of the vehicle. In some embodiments, sales information may include average gross 1253 for the vehicle and unit sales 1255 for the vehicle. In some embodiments, detailed vehicle information 1251 may include dealership, group, regional, and national sales statistics. In some embodiments, detailed vehicle information 1251 may be subdivided by time period.

In some embodiments, detailed dealership information 1271 may include detailed target and goal information 1273 for the make and model of the vehicle. The dealership may have monthly or quarterly goals for different makes and/or models of car. Detailed dealership information 1271 may display information relating to the target and goal information 1273 in goal table 1275. In some embodiments, goal table 1275 may include a row corresponding to each goal desired to be tracked. Goal table 1275 may display date range 1277, target sales 1279, and progress toward goal 1281 for each goal displayed. In some embodiments, progress toward goal 1281 may include a graphical indication 1283 for the progress towards the goal. In some embodiments, goal table 1275 may calculate one or more metrics 1285. For example, in some embodiments, metrics 1285 may include a daily rate of sale 1289 necessary to meet the goal. In some embodiments, metrics 1285 may also display the current daily rate of sale 1291. As one of ordinary skill in the art with the benefit of this disclosure will recognize, detailed dealership information 1271 may be customized and include other information than that listed above. In certain embodiments, detailed dealership information 1271 may be displayed on a monitor. In some embodiments, such detailed dealership information may be displayed on a different monitor than that displayed by desking GUI 25.

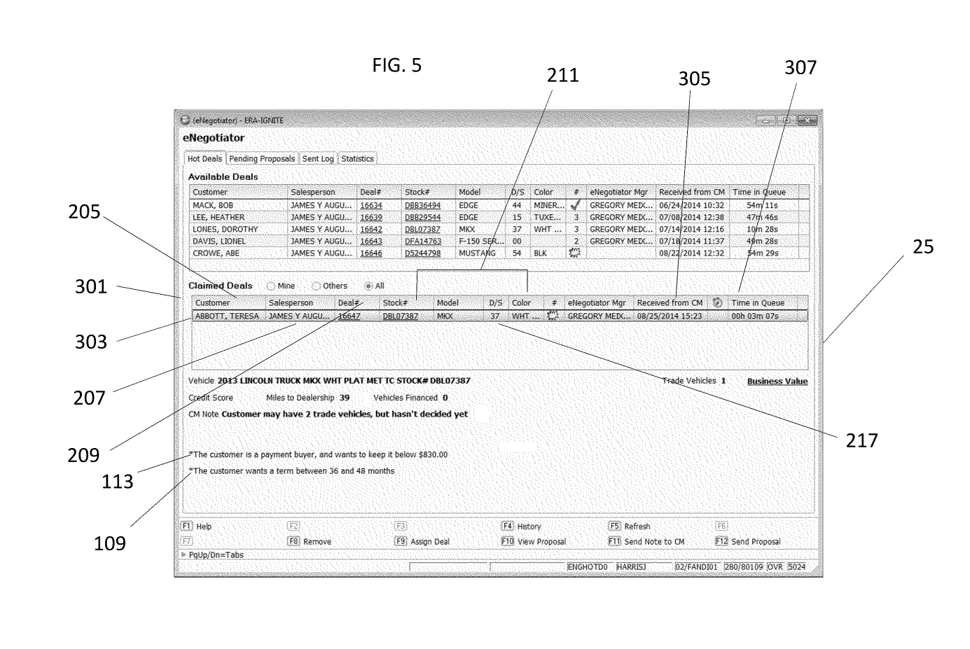

In some embodiments, sales manager 23 at desking terminal 21 may claim (251 in FIG. 2) an available deal request 203, associating the deal with the sales manager 23. The term “claim” may include selection of the deal request by the sales manager 23, assignment of the deal request by another entity, such as the superior of a sales manager 23, or assignment of the deal request based on a set of rules. By claiming the deal request, the claiming sales manager indicates to other sales managers 23 and salespersons 43 that the claiming sales manager will negotiate with customer 51 for sales of a vehicle. Sales manager 23 may claim an available deal request 203 by interacting with desking GUI 25. In some embodiments, the selection and claiming of a deal request may be done by using one or more of keyboard entries or mouse selections. In some embodiments, as depicted in FIG. 5, once claimed, claimed deal request 303 may be displayed in claimed deal request table 301 (shown as “Claimed Deals in FIG. 5) on desking GUI 25. In some embodiments, claimed deal requests table 301 may only display deal requests claimed by the sales manager 23 using desking terminal 21. In some embodiments, the claimed deal request may include an indicator that the deal request is no longer available. In some embodiments, claimed deal request 303 may be removed from available deal request table 201 on all desking terminals. In some embodiments, an available deal request 203 may be assigned by a first sales manager to a second sales manager. The assigned deal request may be associated with the second sales manager as if it were claimed by the second sales manager. Accordingly the assigned deal request may act like claimed deal request 303 for the purposes of this disclosure.

In some embodiments, sales manager 23 may select whether claimed deal requests table 301 displays only deal requests associated with that particular sales manager 23, display only deal requests associated with other sales managers, and/or display all deal requests associated with any sales manager. In some embodiments, claimed deal requests table 301 may display information relating to each claimed deal request 303 including one or more of, without limitation, customer information 205, the name of salesperson 207, the deal identifier 209, vehicle information 211, time the deal request was claimed 305, and the time since the deal request was claimed 307. In some embodiments, only a selected portion of customer information 205 and vehicle information 211 may be shown. For example, only customer information 205 and vehicle information 211 desired to be seen by sales manager 23 may be displayed in claimed deal requests table 301. In some embodiments, sales manager 23 may select which customer information 205 and vehicle information 211 is displayed. In some embodiments, claimed deal requests table 205 may display dealership inventory information 217. In some embodiments, dealership inventory information 217 may be retrieved from a dealership inventory database. In some embodiments, dealership inventory information 217 may include the number of vehicles of the same make and model the dealership currently has in stock. In some embodiments, the dealership inventory information may be retrieved from the dealership inventory database based on any of the model, VIN, stock number, or vehicle identifier provided by the associated deal request 100. In some embodiments, by selecting a claimed deal request 303, additional information relating to the claimed deal request 303 may be displayed by desking GUI 25. The additional information may include, for example and without limitation, customer information, vehicle information, trade-in vehicle information, dealership inventory information, and desired terms of sale 109 submitted by customer 51 in deal request 100 as well as any notes 113 included therewith.

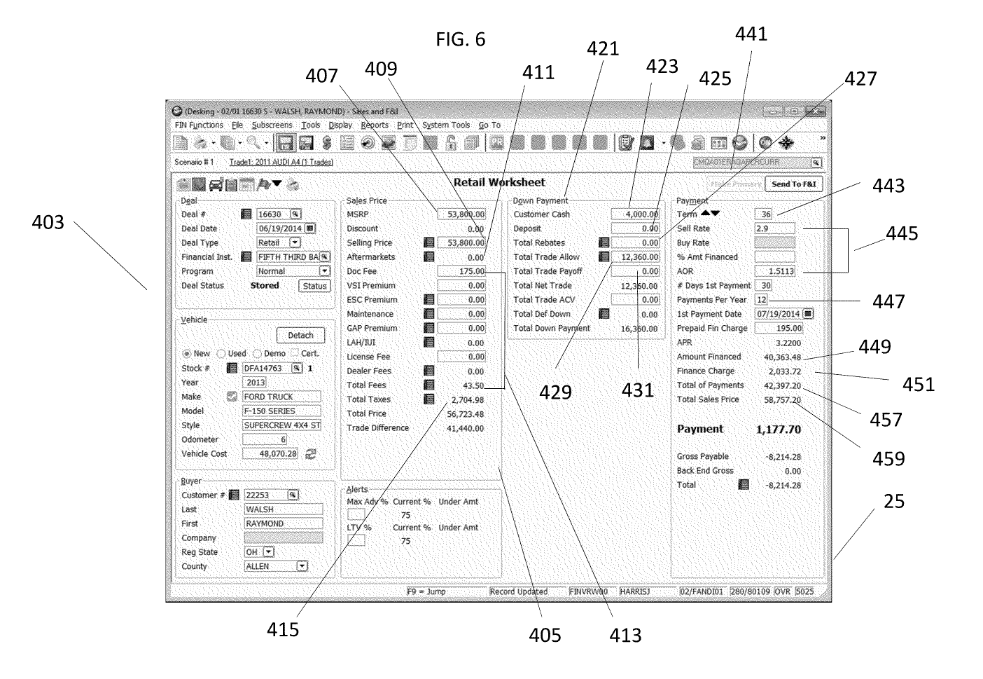

In some embodiments, sales manager 23 associated with claimed deal request 303 may create a deal proposal (401 in FIG. 2). In some embodiments, as depicted in FIG. 6, desking terminal 21 may provide deal proposal worksheet 403 to allow sales manager 23 to determine the terms available to be offered to customer 51. Deal proposal 401 may be stored in a non-transitory, tangible computer readable storage medium. In some embodiments, sales manager 23 may be able to input financial information relating to the deal proposal. The financial information may include, for example and without limitation, sales price 405, down payment information 421, and regular payment terms 441. In some embodiments, sales price 405 may be determined from one or more of MSRP 407, selling (or sticker) price 409, aftermarket additions 411, any fees 413, any taxes 415, and any trade-in vehicle value. Down payment information 421 may include customer cash down payment 423, any deposits 425, any rebates 427, total value of any trade-in vehicles 429, and total payoff amount 431 of any trade-in vehicles. Regular payment terms 441 may include financing term 443, financing rate 445, number of regular payments per year 447, the amount financed 449, financing charges 451, payment totals 457, and total sale price 459. In some embodiments, one or more of these pieces of information is automatically determined or calculated from entries elsewhere in deal proposal worksheet 403.

In some embodiments, sales manager 23 may utilize deal proposal worksheet 403 to determine an optimal set of terms of sale based in part on customer 51's desired terms of sale 109 provided in deal request 100. As understood by one having ordinary skill in the art with the benefit of this disclosure, a dealership may not be able to simultaneously meet all desired terms of sale 109 desired by a customer. Sales manager 23 may alter one or more terms of sale until sales manager 23 deems the terms of sale appropriate to be submitted to customer 51. Sales manager 23 may also change vehicle financing information such as purchase versus lease or a change in the financial institution.

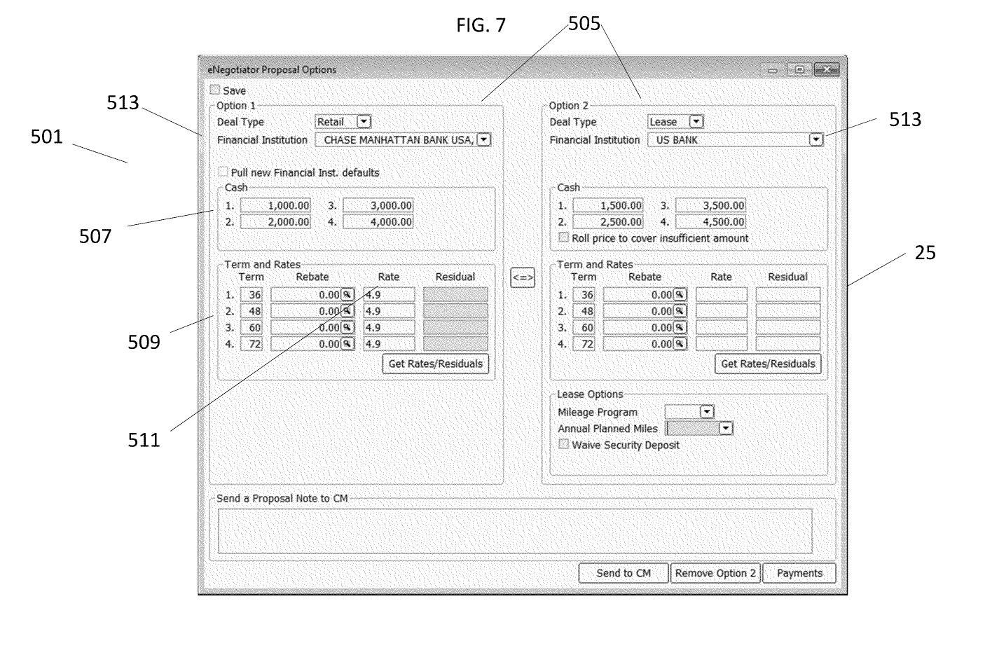

In some embodiments, as depicted in FIG. 7, desking terminal 21 may provide deal proposal form 501 to allow sales manager 23 to create a deal proposal to submit to customer 51. In some embodiments, sales manager 23 may import the terms of sale formulated on deal proposal worksheet 403 into deal proposal form 501. In some embodiments, deal proposal form 501 may allow sales manager 23 to submit multiple proposals 505 to customer 51. In some embodiments, each proposal 505 may include the terms of sale selected by sales manager 23 on deal proposal worksheet 403. In some embodiments, each proposal 505 may include calculated terms of sale based on variations in one or more other terms of sale. For example and without limitation, the deal proposal may display terms of sale such as regular payment for multiple down payment amounts 507, varying financing terms 509, varying rates of interest 511, or different financial institutions 513. In some embodiments, the terms of sale may have default values preconfigured or configured by sales manager 23. In some embodiments, sales manager 23 may vary the terms of sale in deal proposal form 501. In some embodiments, the deal proposal form 501 may also allow sales manager 23 to include one or more notes which may be relevant to customer 51 or salesperson 43 in reviewing the deal proposal.

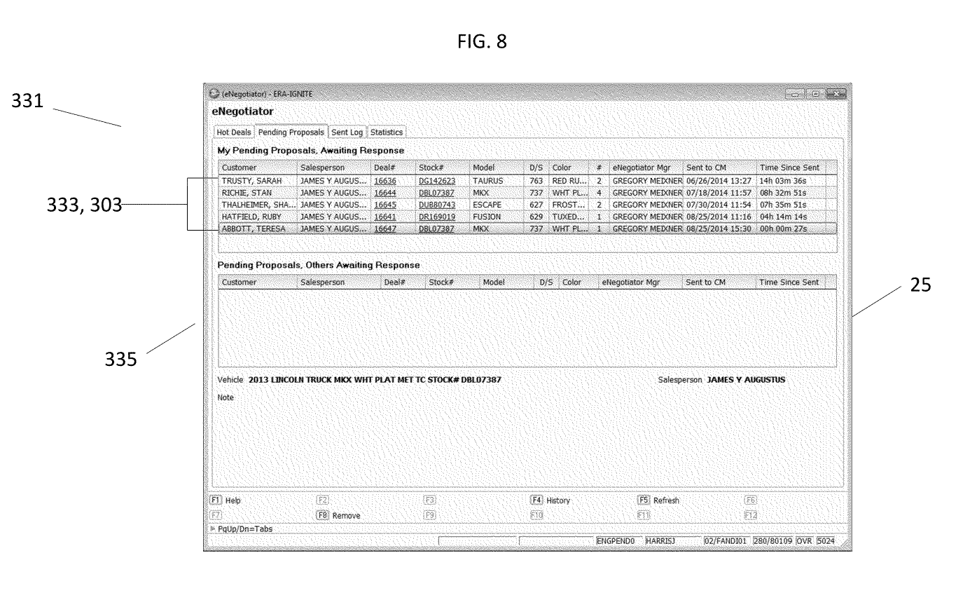

In some embodiments, once sales manager 23 completes deal proposal form 501, sales manager 23 may submit the proposals 505 formulated by deal proposal form 501 as a collective deal proposal 401 to sales terminal 41. Proposals 505 may be stored in a non-transitory, tangible computer readable storage medium. In some embodiments, claimed deals table 301, as previously discussed, may indicate that deal proposal 401 has been submitted for the corresponding claimed deal 303. In some embodiments, as depicted in FIG. 8, desking GUI 25 may provide a list of pending deal proposals. Pending deal proposals are deal proposals not yet accepted or rejected by customer 51. In some embodiments, the pending deal proposals may be displayed in pending deal proposal table 331. Pending deal proposals may be stored in a non-transitory, tangible computer readable storage medium. In some embodiments, pending deal proposal table 331 may display only pending deal proposals 333 for claimed deal requests 303 associated with the particular sales manager 23. In some embodiments, a pending deal proposal table may display only pending deal proposals for claimed deal requests associated with other sales managers, denoted 335 in FIG. 8. In some embodiments, the pending deal proposal table may display pending deal proposals for all claimed deal requests (not shown). In some embodiments, multiple pending deal proposal tables 331, 335 may be displayable which may display one or more of claimed deal requests associated with the particular sales manager (331) and pending deal proposals associated with other sales managers (335). In some embodiments, by selecting a deal proposal, additional information relating to the deal proposal may be displayed by desking GUI 25. The additional information may include, for example and without limitation, customer information, vehicle information, trade-in vehicle information, dealership inventory information, and the terms of sale submitted in the deal proposal to customer, as well as any notes included therewith.

In some embodiments, once submitted, deal proposal 401 may be sent to sales terminal 41 for review (601 in FIG. 2) by customer 51. In some embodiments, one or more received deal proposal indicators may indicate that a deal proposal has been received. Received deal proposal indicators may include, for example and without limitation, sounds, lights, or indicators in sales GUI 45. Indicators in sales GUI 45 may include without limitation popups, alert boxes, dialog boxes, or graphical indications that a deal proposal has been received. In some embodiments, sales GUI 45 may provide a button or link to allow customer 51 to view deal proposal 401.

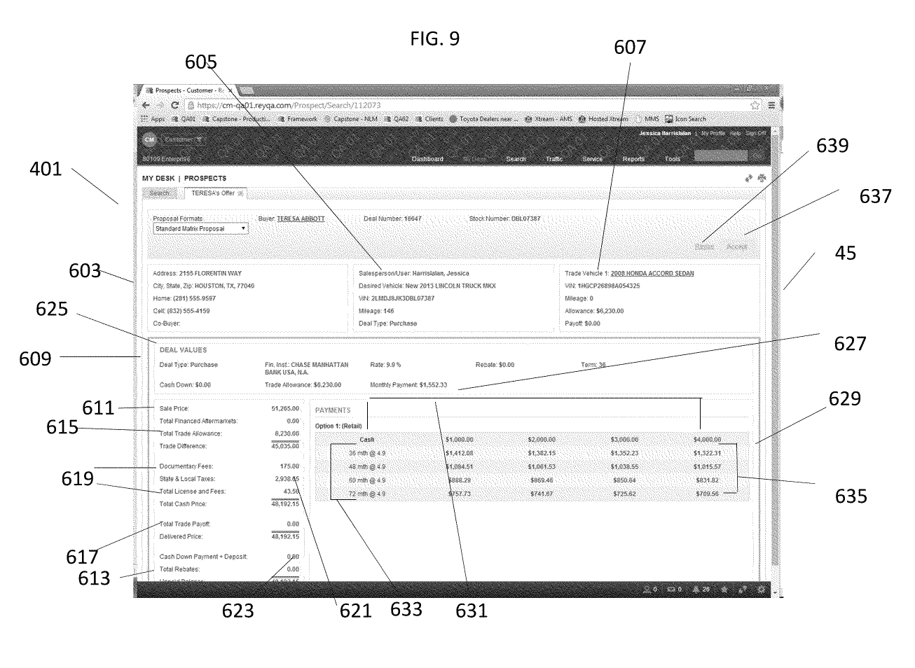

Once selected, as depicted in FIG. 9, sales GUI 45 may display deal proposal 401 to customer 51 for review. In some embodiments, deal proposal 401 may be displayed along with customer information 603, vehicle information 605, and trade-in vehicle information 607. In some embodiments, deal proposal 401 may be displayed with financial information 609 relating to deal proposal 401. For example, in some embodiments, financial information 609 may display a breakdown of the calculation for the total amount to be financed. In some embodiments, the breakdown may indicate sale price 611, any discounts or rebates 613, trade-in vehicle value 615 and payoff amounts 617, any fees 619 and taxes 621, and down payment amounts 623. In some embodiments, the deal proposal may display terms of sale 625, such as for example regular payments 627, corresponding with desired terms of sale 109 indicated by customer 51 in deal request 100.

In some embodiments, the multiple proposals 505 contained in deal proposal 401 may be displayed as one or more proposal tables 629. Multiple proposals 505 may include a first proposal having first terms of sale and a second proposal having second terms of sale. Proposal tables 629 may be configured to display multiple proposals 505 according to certain terms of sales. For example, in embodiments in which proposals are calculated for varying down payment amounts 631 and financing terms 633, a proposal table 629 may include columns indicating down payment amounts 631, rows indicating financing terms 633, with the individual cells displaying regular payments corresponding to a proposal 635 having down payment amount and financing term of its corresponding column and row respectively. In some embodiments, additional proposal tables 629 may be displayed with further variations in terms of sale.

In some embodiments, if satisfied with the terms of sale corresponding to a displayed proposal 635, customer 51 may accept the proposal. “Accepting” the proposal means that the customer has agreed to the terms of sale for purchase of the vehicle. In some embodiments, customer 51 may select the desired proposal 635 in sales GUI 45 to accept the proposal 635 (651 in FIG. 2). In some embodiments, customer 51 may be presented with a button or link 637 to accept a selected proposal 635. Once customer 51 accepts a proposal 635, the selected proposal 635 may be sent from sales terminal 41 to desking terminal 21 to be accessed by sales manager 23. In some embodiments, one or more accepted proposal indicators may indicate that an accepted proposal has been received. Accepted deal proposals may be stored in a non-transitory, tangible computer readable storage medium. Received accepted proposal indicators may include, for example and without limitation, sounds, lights, or indicators in desking GUI 25. Indicators in desking GUI 25 may include without limitation popups, alert boxes, dialog boxes, or graphical indications that an accepted proposal has been received. In some embodiments, the pending deal proposal 333 associated with the accepted proposal 635 may be removed from pending deal proposal table 331 as depicted in FIG. 8. In some embodiments, a claimed deal 303 corresponding with the accepted proposal 635 may be added to claimed deals table 301 as depicted in FIG. 5. Sales manager 23, salesperson 43, and/or customer 51 may then proceed with finalizing the sale of the vehicle (653 in FIG. 2).

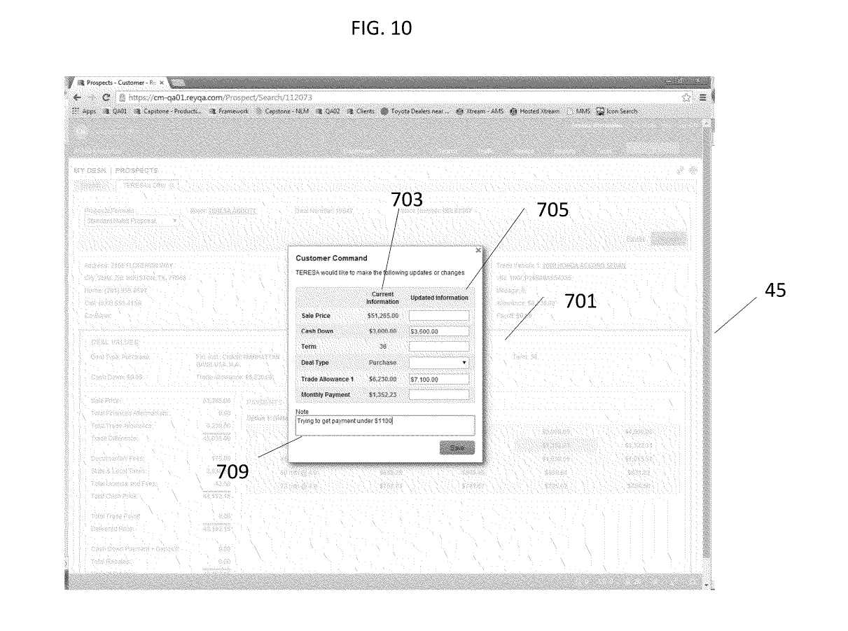

In some embodiments, if customer 51 is not satisfied with the terms of sale corresponding to the any displayed proposal 635, customer 51 may submit revised proposed terms of sale (700 in FIG. 2). Revised proposed terms of sale may be stored in a non-transitory, tangible computer readable storage medium. In some embodiments, as depicted in FIG. 10, customer 51 may be presented with revised deal proposal form 701 on sales GUI 45 of sales terminal 41. In some embodiments, revised deal proposal form 701 may be presented in a dialog box. In some embodiments, the previous proposed terms of sale 703 may be displayed generally aligned with or generally adjacent to input boxes for revised proposed terms of sale 705. In some embodiments, previous proposed terms of sale 703 may correspond with the proposed terms of sale provided in deal request 100 or with a previously submitted revised deal proposal form 701. In some embodiments, previous proposed terms of sale 703 may correspond with a proposal 635 submitted by sales manager 23. In some embodiments, as depicted in FIG. 9, customer 51 may select a displayed proposal 635 which most closely matches customer 51's desired terms of sale. In such embodiments, customer 51 may be presented with a button or link 639 to bring up revised deal proposal form 701.

Referring again to FIG. 10, customer 51 may input revised proposed terms of sale 705 into revised deal proposal form 701. In some embodiments, customer 51 may input revised proposed terms of sale 705 for only a subset of the terms of sale displayed. In some embodiments, customer 51 may input revised proposed terms of sale 705 for only a subset of the revised desired terms of sale. For example, customer 51 may be more interested in lowering the regular payment of the proposal than lowering the overall price for the vehicle of the deal proposal. In some embodiments, the revised deal proposal form may also allow customer 51 to include one or more notes 709 which may be relevant to sales manager 23 in reviewing revised terms of sale 705 of revised deal proposal form 701.

Once satisfied with the revised proposed terms of sale, customer 51 may submit the revised deal proposal form. Once submitted, the revised deal proposal form may be sent from sales terminal 41 to desking terminal 21 to be reviewed by sales manager 23 (800 in FIG. 2). In some embodiments, one or more received revised deal proposal form indicators may indicate that a revised deal proposal form has been received. Received revised deal proposal form indicators may include, for example and without limitation, sounds, lights, or indicators in desking GUI 25. Indicators in desking GUI 25 may include without limitation popups, alert boxes, dialog boxes, or graphical indications that a revised deal proposal form has been received.

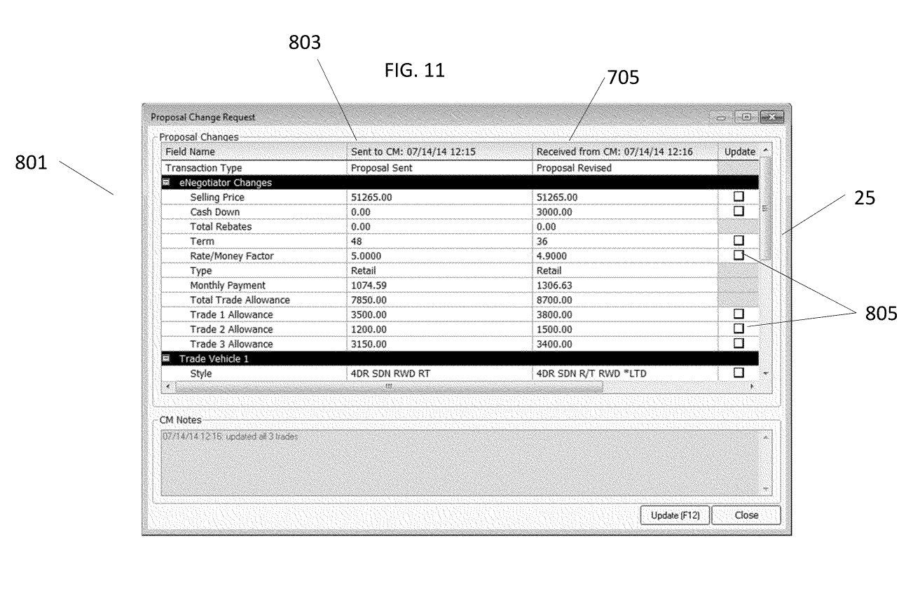

In some embodiments, the pending deal proposal 333 associated with revised deal proposal form 701 may be removed from pending deal proposal table 331 as depicted in FIG. 8. In some embodiments, a claimed deal request 303 corresponding with the accepted proposal 635 may be added to claimed deal requests table 301 as depicted in FIG. 5. In some embodiments, desking GUI 25 may indicate that revisions to proposal 635 have been submitted. In some embodiments, desking GUI 25 may provide a button or link to display the revised proposed terms of sale 705 of revised deal proposal form 701. In some embodiments, as depicted in FIG. 11, sales manager 23 may view the revised proposed terms of sale 705 in revised proposed terms of sale table 801. In some embodiments, revised proposed terms of sale 705 may be displayed along with the terms of sale of the previous deal proposal 803. In some embodiments, the terms of sale of the previous deal proposal may correspond with the proposal 635 selected by customer 51 to be revised as previously discussed. In some embodiments, the terms of sale of the previous deal proposal 803 may be displayed generally aligned with or generally adjacent to the revised proposed terms of sale 705. In some embodiments, desking GUI 25 may allow sales manager 23 to indicate any revised proposed terms of sale that sales manager 23 approves, such as, for example and without limitation, by checking a checkbox 805. In some embodiments, any approved revised terms of sale 705 may be incorporated into a new deal proposal. In some embodiments, sales manager 23 may approve all terms of a revised deal proposal, creating an accepted deal. In some embodiments, the approved revised terms of sale may be inserted into the otherwise unchanged previous deal proposal 401 and may be resubmitted to customer 51 automatically.

In some cases, sales manager 23 may not approve any of the revised proposed terms of sale. In some embodiments, sales manager 23 may adjust one or more terms of sale from the previous deal proposal. In some embodiments, desking GUI 25 may allow sales manager 23 to input one or more adjusted terms of sale. In some embodiments, the adjusted terms of sale may be incorporated into a new deal proposal. In some embodiments, the approved revised terms of sale may be inserted into the otherwise unchanged previous deal proposal 401 and may be resubmitted to customer 51 automatically.

In some embodiments, customer 51 may then review the new deal proposal and accept or revise it accordingly as discussed above. This process may repeat until customer 51 accepts a deal proposal submitted by sales manager 23.

In some embodiments, if action is not taken on a claimed deal request within a predetermined amount of time since the last communication from sales terminal 41 for a claimed deal request, sales manager 23 associated with the claimed deal request may be removed therefrom (901 in FIG. 2), reverting the claimed deal to an available deal request and allowing another sales manager to claim the deal request or assign the deal request to another sales manager. In some embodiments, the action taken may include, for example and without limitation, reviewing the claimed deal request, initiating a deal proposal, or submitting a deal proposal. In some embodiments, one or more time warning indicators that the predetermined amount of time has nearly expired may be made on desking terminal 21 associated with sales manager 23 associated with the claimed deal request. Time warning indicators may include, for example and without limitation, sounds, lights, or indicators in desking GUI 25. Indicators in desking GUI 25 may include without limitation popups, alert boxes, dialog boxes, or graphical indications that a claimed deal request is approaching its time limit.

In some embodiments, sales manager 23 may at any time send a note to customer 51 or salesperson 43 from desking GUI 25. In some embodiments, sales terminal 41 may provide an indicator that a note has been received. Received note indicators may include, for example and without limitation, sounds, lights, or indicators in sales GUI 45. Indicators in sales GUI 45 may include without limitation popups, alert boxes, dialog boxes, or graphical indications that a note has been received. In some embodiments, the sent note may appear on sales GUI 45 of sales terminal 41 as, for example and without limitation, a popup, alert box, dialog box, e-mail (internal or external) or graphical indication that a note from sales manager 23 is available. In some embodiments, in which a graphical indication that a note from sales manager 23 is available is displayed, sales GUI 45 may provide customer 51 or salesperson 43 a button or link to display the note.

In some embodiments, customer 51 or salesperson 43 may at any time send a note to sales manager 23 from sales GUI 45. In some embodiments, desking terminal 21 may provide an indicator that a note has been received. Received note indicators may include, for example and without limitation, sounds, lights, or indicators in desking GUI 25. Indicators in desking GUI 25 may include without limitation popups, alert boxes, dialog boxes, or graphical indications that a note has been received.

In some embodiments, upon receipt of a communication, i.e. a deal request, deal proposal, revised deal proposal form, new deal proposal, or note, the recipient, being sales manager 23, salesperson 43, or customer 51, may acknowledge receipt of the communication. In some embodiments, the receiving terminal may automatically acknowledge that the communication has been received. In some embodiments, the receiving terminal may automatically acknowledge that the communication has been viewed by the corresponding user of the terminal. In some embodiments, all received and/or sent communications may be logged by the sending and/or receiving terminal. In some embodiments, all received and/or sent communications may be listed in, for example and without limitation, an alert box.

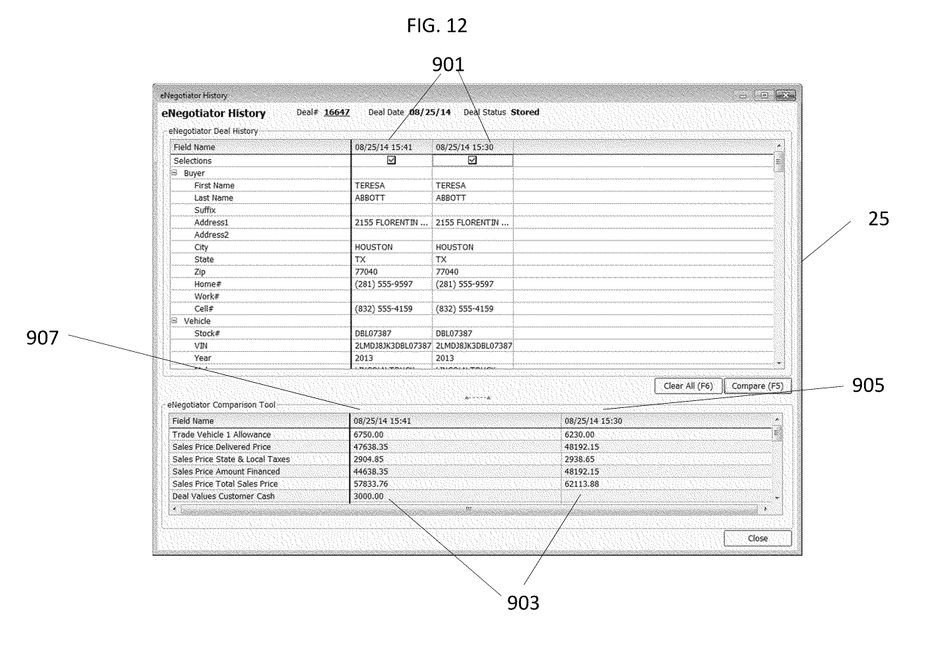

In some embodiments, all communications of a deal negotiation may be logged and stored in a non-transitory, tangible computer readable storage medium. As depicted in FIG. 12, in some embodiments, communications 901 may be displayed. In some embodiments, terms of sale 903 of communications 901 may be displayed such that terms of sale 903 may be tracked, for example, from deal request 905 through accepted deal 907. In some embodiments, this deal history may be used to, for example and without limitation, compare different deal negotiations or train sales managers. In some embodiments, the tracked terms of sale 903 may be placed in a chart or other graphic to facilitate easier determination of how terms of sale have changed through successive iterations.

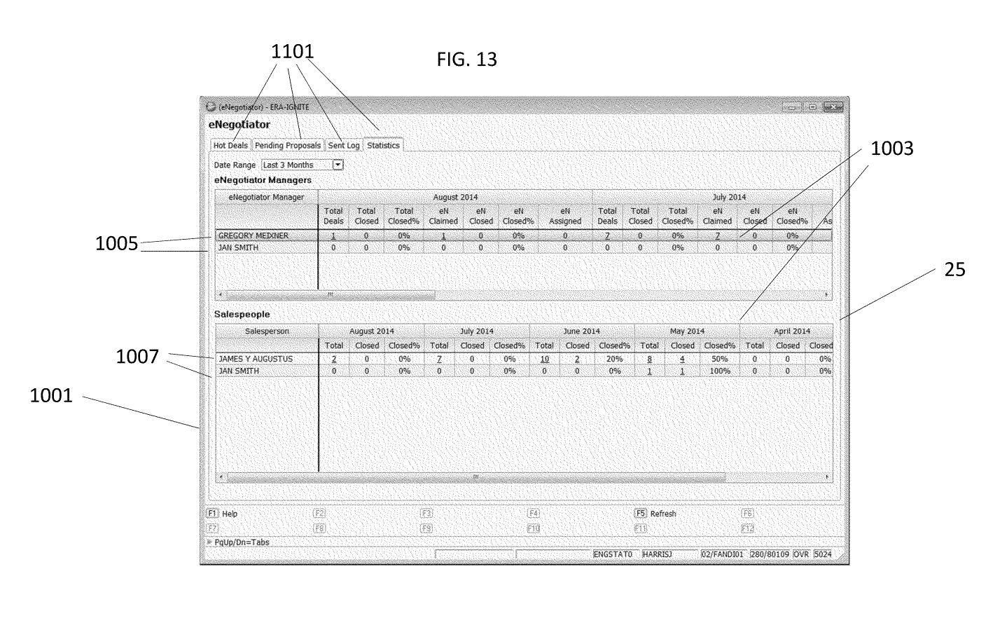

In some embodiments, statistics may be gathered relating to the handling of a claimed deal request by a sales manager. In some such embodiments, as depicted in FIG. 13, statistics 1003 may be displayed in statistics table 1001 relating to each sales manager 1005 or salesperson 1007. Statistics 1003 may be gathered from data logged and/or tracked in each deal negotiation. Statistics 1003 may include, for example and without limitation, time from claiming of a deal to acceptance, time from claiming of a deal to sending a deal proposal, time from receiving a revised terms of sale form to sending a new proposal, difference between accepted proposal and initial proposal, number of accepted proposals per claimed deals, number of claimed deal requests which reach the predetermined time limit, overall number of claimed deals, and overall number of accepted proposals.

In some embodiments, desking GUI 25 may allow sales manager 23 to view selected information. In some embodiments, as depicted in FIGS. 4, 5, 8, and 13, desking GUI 25 may include one or more “tabs” 1101 as understood in the art to organize the available information. In some embodiments, desking GUI 25 may include one or more “windows” as understood in the art. In some embodiments, one window may be dedicated to, for example and without limitation, a deal worksheet, deal proposal, detailed dealership information, or detailed customer information as previously described. In some embodiments, one window may include multiple tabs. In some such embodiments, for example and without limitation, one tab may include available deal requests table 201, claimed deal requests table 301, and an area to display additional information for a selected available or claimed deal as discussed previously. Another tab may include any pending deal proposal tables 331, another tab may display a communication log, and another tab may display statistics table 1001 as discussed previously. In some embodiments, desking terminal 21 may include multiple displays, allowing, for example and without limitation, a sales manager to view multiple windows simultaneously.

In some embodiments, the information available to sales manager 23 using a given desking terminal may be limited. For example, a senior sales manager may have access to previously discussed information a junior sales manager does not. For example, a junior sales manager may be prohibited from, for example and without limitation, assigning available deals to other sales managers, viewing statistics, or viewing claimed deals and proposals of other sales managers.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure and that they may make various changes, substitutions, and alterations herein without departing from the spirit and scope of the present disclosure.

1. A method comprising:
providing a sales terminal and a desking terminal;
creating a deal request on the sales terminal;
transmitting the deal request from the sales terminal to the desking terminal;
claiming the deal request on the desking terminal;
creating a deal proposal on the desking terminal;
transmitting the deal proposal from the desking terminal to the sales terminal.

2. The method of claim 1, further comprising:
reviewing the deal proposal on the sales terminal; and
accepting the deal proposal.

3. The method of claim 1, further comprising:
reviewing the deal proposal on the sales terminal;
creating a revised deal proposal on the sales terminal; and
transmitting the revised deal proposal from the sales terminal to the desking terminal.

4. The method of claim 3, further comprising:
reviewing the revised deal proposal on the desking terminal; and
accepting the revised deal proposal on the desking terminal.

5. The method of claim 3, further comprising:
reviewing the revised deal proposal on the desking terminal;
repeating the creating a deal proposal operation on the desking terminal; and
transmitting the revised deal proposal from the desking terminal to the sales terminal.

6. The method of claim 1, wherein the creating a deal request operation further comprises:
displaying a questionnaire by a sales GUI of the sales terminal;
entering at least one datum into the questionnaire; and
creating the deal request using at least the one datum.

7. The method of claim 6, wherein the questionnaire comprises a form.

8. The method of claim 1, wherein the deal request comprises at least one datum of customer information, vehicle information, vehicle financing information, trade-in vehicle information, or desired terms of sale.

9. The method of claim 8, wherein the customer information comprises at least one of a customer's name, address, financial information, amount of total sales to the customer, amount of new vehicle sales to the customer, amount of used vehicle sales to the customer, amount of service sales to the customer, customer credit score, or customer credit report.

10. The method of claim 8, wherein the vehicle information comprises at least one of model year, make, model, mileage, color, VIN, stock number, photograph, or available and installed options.

11. The method of claim 8, wherein the vehicle financing information comprises at least one of whether the customer is interested in purchasing or leasing the vehicle or a financial institution that the customer may use to finance any purchase or lease.

12. The method of claim 8, wherein the trade-in vehicle information comprises at least one of the model year, make, model, mileage, VIN, current financing terms, or current financing status of a trade-in vehicle offered or offerable by the customer.

13. The method of claim 8, wherein the desired terms of sale comprise at least one of maximum or desired regular payment for the vehicle, a desired trade-in value for any trade-in vehicles, a down payment amount, desired financing term, desired financing rate, or overall price for the vehicle.

14. The method of claim 8, wherein the datum is entered into the sales terminal.

15. The method of claim 8, wherein the datum is retrieved from a database.

16. The method of claim 1, further comprising:
displaying the deal proposal by a desking GUI of the desking terminal.

17. The method of claim 16, wherein, before the deal proposal is claimed, the deal proposal defines an available deal request, the available deal request displayed by the desking GUI in an available deal requests table.

18. The method of claim 17, wherein the available deal requests table is adapted to display available deal requests transmitted by multiple sales and/or desking terminals.

19. The method of claim 17, wherein when the available deal request is claimed, removing the claimed deal request from the available deal requests table and displaying the claimed deal request in a claimed deal requests table.

20. The method of claim 19, wherein, after a predetermined amount of time after transmitting the deal request from the sales terminal to the desking terminal or before a preselected activity occurs on the desking terminal, the claimed deal request is reverted to an available deal request.

21. The method of claim 16, wherein the desking GUI is adapted to display detailed information, the detailed information comprising at least one of detailed customer information, detailed trade-in information, detailed vehicle information, and detailed dealership information.

22. The method of claim 21, wherein the detailed customer information comprises at least one of total business generated by the customer; new vehicle sales, used vehicle sales, or service sales made to the customer; distance between the customer and a dealership; the number of vehicles financed by the customer; credit score for the customer; or a favorability score.

23. The method of claim 22, wherein the favorability score is determined from at least one other datum of the detailed customer information.

24. The method of claim 21, wherein the detailed trade-in information comprises at least one of a list of vehicles currently owned by the customer, where any such vehicles were purchased, where any such vehicles are serviced, whether any such vehicles were purchased new or used, or sales information for any such vehicles.

25. The method of claim 24, wherein the sales information comprises statistics on sales of the vehicle.

26. The method of claim 21, wherein the detailed vehicle information comprises at least one of sales information for the make and model of the vehicle, average gross price for the vehicle make and model, or number of sales of the vehicle make and model by a dealership.

27. The method of claim 21, wherein the detailed dealership information comprises target or goal information for the make and model of the vehicle.

28. The method of claim 27, wherein the target or goal information comprises sales goals for the make and/or model of the vehicle.

29. The method of claim 27, wherein the target or goal information comprises progress information on any targets or goals.

30. The method of claim 27, wherein the desking GUI is adapted to display one or more metrics relating to the target or goal information, comprising at least one of number of vehicles remaining to be sold to meet a goal, number of vehicles per time period to be sold to meet the goal, or the current or a past rate of sale of vehicles.

31. The method of claim 1, wherein the deal proposal comprises a first proposal, the first proposal including a first terms of sale.

32. The method of claim 31, wherein the first terms of sale are formulated from at least one of sales price, down payment information, or regular payment terms.

33. The method of claim 32, wherein the sales price is determined from at least one of MSRP, selling price, aftermarket additions, fees, taxes, and any trade-in vehicle value.

34. The method of claim 32, wherein the down payment information includes at least one of customer cash down payment, deposits, rebates, total value of any trade-in vehicle, and total payoff amount of the any trade-in vehicle.

35. The method of claim 32, wherein the regular payment terms include at least one of financing term, financing rate, number of regular payments per year, amount financed, financing charges, payment totals, and total sale price.

36. The method of claim 32, wherein at least one term of sale of the first terms of sale is calculated from at least one other term of sale of the first terms of sale.

37. The method of claim 32, wherein the first terms of sale are entered and modified in a deal proposal worksheet displayed by a desking GUI of the desking terminal.

38. The method of claim 31, wherein the deal proposal comprises multiple proposals, each proposal including corresponding terms of sale.

39. The method of claim 31, wherein the deal proposal further comprises a first proposal and a second proposal, the second proposal including terms of sale wherein at least one term of sale is different from the terms of sale of the first proposal.

40. The method of claim 31, wherein the first terms of sale comprise at least one of regular payment for the vehicle, trade-in value for any trade-in vehicles, down payment amount, financing term, financing rate, or overall price for the vehicle.

41. The method of claim 31, wherein once transmitted, the deal proposal is displayed by a desking GUI of the desking terminal in a pending deal proposal table.

42. The method of claim 3, wherein, once received by the sales terminal, a sales GUI of the sales terminal displays the terms of sale of the deal proposal.

43. The method of claim 42, wherein the deal proposal comprises a first and a second proposal, each proposal including corresponding first and second terms of sale, the sales GUI displaying the first and second terms of sale.

44. The method of claim 44, wherein the first and second terms of sale include at least one different term of sale, and the first and second terms of sale are displayed by the sales GUI.

45. The method of claim 42, wherein the sales GUI is adapted to allow accept the deal proposal.

46. The method of claim 42, wherein the sales GUI is adapted to allow a user to revise the deal proposal.

47. The method of claim 46, wherein the sales GUI is adapted to display a table allowing the user to input one or more revised terms of sale.

48. The method of claim 47, wherein the sales terminal is adapted to combine any revised terms of sale with any terms of sale of the revised deal proposal.

49. The method of claim 47, wherein the sales terminal is adapted to transmit the revised deal proposal to the desking terminal.

50. The method of claim 1, further comprising transmitting a note from the sales terminal to the desking terminal or from the desking terminal to the sales terminal.

51. The method of claim 1, further comprising generating an alert by the desking terminal when the deal request is received by the desking terminal.

52. The method of claim 3, further comprising generating an alert by the sales terminal when the deal proposal is received by the sales terminal.

53. The method of claim 1, wherein the sales terminal is adapted to be used by a customer and/or a salesperson, the sales terminal being a computing device such as a desktop computer, laptop computer, slate, tablet, PDA, or smartphone.

54. The method of claim 1, wherein the desking terminal is adapted to be used by a sales manager at a location spaced apart from the first terminal.

55. The method of claim 1, wherein the sales and desking terminals comprise computing devices and communication therebetween operates through a computer network.

56. The method of claim 55, wherein the computer network comprises one or more of a wired or wireless connection.
